(19) United States
(12) Patent Application Publication
(10) Pub. No.: US 2016/0330525 A1
(43) Pub. Date: Nov. 10, 2016

(54) EMERGENCY ALERT SCHEME FOR COMPANION DEVICES BASED ON THE HYBRID BROADCAST BROADBAND TV (HbbTV) 2.0 COMPANION SCREEN DEVICE PROTOCOL

(71) Applicant: Samsung Electronics Co., Ltd, Suwon-si (KR)

(72) Inventors: Martin Freeman, Mountain View, CA (US); Youngsun Ryu, Mountain View, CA (US)

(21) Appl. No.: 15/150,012

(22) Filed: May 9, 2016

Related U.S. Application Data
(60) Provisional application No. 62/158,962, filed on May 8, 2015.

(51) Int. Cl. H04N 21/488; H04N 21/6405; H04N 21/236; H04L 29/08; H04W 4/22

(52) U.S. Cl. CPC H04N 21/4882; H04L 67/02; H04W 4/22; H04N 21/23614; H04N 21/6405

(57) ABSTRACT

A method and apparatus are provided for sending an emergency alert message to a companion device. The apparatus includes a memory element and a processor coupled to the memory element. The processor is configured to receive an emergency alert message (EAM) in an advanced television systems committee (ATSC) signal. The processor is also configured to identify any companion devices that comprise a launcher application capable of being used by the apparatus. The processor is also configured to send a command to the launcher application capable of causing the launcher application to execute an application to an identified companion device that comprises the launcher application. The application is capable of accessing the EAM.

### CROSS-REFERENCE TO RELATED APPLICATION AND CLAIM OF PRIORITY

This application claims priority under 35 U.S.C. §119(e) to U.S. Provisional Patent Application No. 62/158,962 filed on May 8, 2015. The above-identified provisional patent application is hereby incorporated by reference in its entirety.

### TECHNICAL FIELD

This disclosure relates generally to companion screen device communication. More specifically, this disclosure relates to an emergency alert scheme for companion devices based on the HbbTV 2.0 companion screen device protocol.

### BACKGROUND

Companion devices are handheld devices available over the local area network. Some handheld cell phones receivers receive and process emergency alerts from local cell phone towers using the Wireless Emergency Alerts scheme. In this case both the cell phone tower and the cell phone need to implement the Wireless Emergency Alerts protocol. In many instances, no companion devices receive emergency alert messages that the companion devices can render, but rather receive terrestrial broadcast with such alerts embedded in the video and audio.

### SUMMARY

This disclosure provides an emergency alert scheme for companion devices based on the HbbTV 2.0 companion screen device protocol.

In a first embodiment, an apparatus is provided for sending an emergency alert message to a companion device. The apparatus includes a memory element and a processor coupled to the memory element. The processor is configured to receive an emergency alert message (EAM) in an advanced television systems committee (ATSC) signal. The processor is also configured to identify any companion devices that comprise a launcher application capable of being used by the apparatus. The processor is also configured to send a command to the launcher application capable of causing the launcher application to execute an application to an identified companion device that comprises the launcher application. The application is capable of accessing the EAM.

In a second embodiment, a method is provided for sending an emergency alert message to a companion device. The method includes receiving an emergency alert message (EAM) in an advanced television systems committee (ATSC) signal. The method also includes identifying any companion devices that comprise a launcher application capable of being used by the apparatus. The method also includes sending a command to the launcher application capable of causing the launcher application to execute an application to an identified companion device that comprises the launcher application. The application is capable of accessing the EAM.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of this disclosure and its advantages, reference is now made to the following description, taken in conjunction with the accompanying drawings, in which:

FIG. 1 illustrates an example computing system according to this disclosure;

FIGS. 2 and 3 illustrate example devices in a computing system according to this disclosure;

FIG. 4 illustrates example EAS home network architecture according to various embodiments of the present disclosure;

FIG. 5 illustrates an example EAS protocol according to various embodiments of the present disclosure;

FIG. 6 illustrates a process for rendering an emergency alert message on a CD display using WebSocket communication in accordance with various embodiments of the present disclosure;

FIG. 7 illustrates a process for rendering an emergency alert message on a CD display using a URL referencing the EAM on the PD in accordance with various embodiments of the present disclosure;

FIG. 8 illustrates a process for rendering an emergency alert message on a CD display using multicast communication in accordance with various embodiments of the present disclosure; and

FIG. 9 illustrates a process for rendering an emergency alert message on a CD display using WebSocket communication by starting in the CD in accordance with various embodiments of the present disclosure.

### DETAILED DESCRIPTION

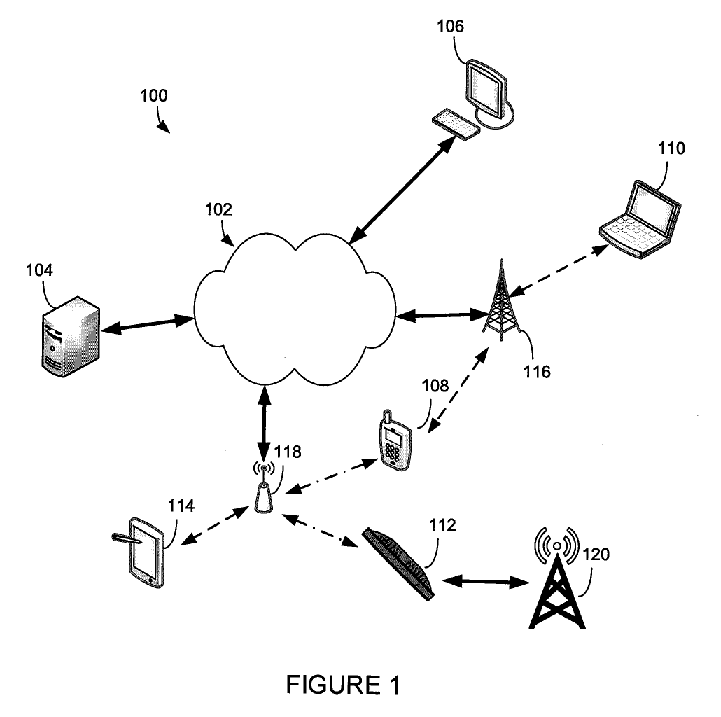

FIGS. 1 through 9, discussed below, and the various embodiments used to describe the principles of this disclosure in this patent document are by way of illustration only and should not be construed in any way to limit the scope of the disclosure. Those skilled in the art will understand that the principles of this disclosure may be implemented in any suitably arranged wireless communication system.

The following acronyms and abbreviations are used within this disclosure:
ATSC—Advanced Television Systems Committee
EA—Emergency Alert
EAM—Emergency Alert Message
ESG—Electronic Service Guide
CD—ATSC Companion Device
HbbTV—Hybrid Broadcast Broadband Television
HTML5—Hyper Text Markup Language 5
HTTP—HyperText Transfer Protocol
JSON—JavaScript Object Notation
PD—ATSC Primary Device
SSDP—Simple Service Discovery Protocol

FIG. 1 illustrates an example computing system 100 according to this disclosure. The embodiment of the computing system 100 shown in FIG. 1 is for illustration only. Other embodiments of the computing system 100 could be used without departing from the scope of this disclosure.

As shown in FIG. 1, the system 100 includes a network 102, which facilitates communication between various components in the system 100. For example, the network 102 may communicate Internet Protocol (IP) packets, frame relay frames, Asynchronous Transfer Mode (ATM) cells, or other information between network addresses. The network 102 may include one or more local area networks (LANs), metropolitan area networks (MANs), wide area networks (WANs), all or a portion of a global network such as the Internet, or any other communication system or systems at one or more locations.

The network 102 facilitates communications between at least one server 104 and various client devices 106-114. Each server 104 includes any suitable computing or processing device that can provide computing services for one or more client devices. Each server 104 could, for example, include one or more processing devices, one or more memories storing instructions and data, and one or more network interfaces facilitating communication over the network 102.

Each client device 106-114 represents any suitable computing or processing device that interacts with at least one server or other computing device(s) over the network 102. In this example, the client devices 106-114 include a desktop computer 106, a mobile telephone or smartphone 108, a laptop computer 110, a television (TV) 112, and a tablet computer 114. However, any other or additional client devices could be used in the computing system 100.

In this example, some client devices 108-114 communicate indirectly with the network 102. For example, the client devices 108-110 communicate via one or more base stations 116, such as cellular base stations or eNodeBs. Also, the client devices 112-114 communicate via one or more wireless access points 118, such as IEEE 802.11 wireless access points. Note that these are for illustration only and that each client device could communicate directly with the network 102 or indirectly with the network 102 via any suitable intermediate device(s) or network(s).

TV 112 can further be wired or wirelessly connected to an ATSC transmitter 120. The ATSC transmitter is configured to perform digital television content transmission over terrestrial, cable, and satellite networks. The TV 112, or a set-top/converter box connected to the TV 112, can perform as an ATSC receiver. The TV 112 can receive the transmission from the ATSC transmitter 120. As described in more detail below, this disclosure specifies the communication protocol between an ATSC primary device and an ATSC companion device. As discussed herein, the primary device is the primary receiver, such as the ATSC receiver, and is used to present the primary content. The companion device communicates with the primary device to present related, supplementary content, or even the same content as that being presented on the primary device. Examples of primary devices include television sets 112, set-top/converter boxes, and mobile devices that are capable of receiving ATSC 3.0 services. Examples of companion devices are laptops 110, tablets 114 and smartphones 108. Further explanation of primary and companion devices can be found in HbbTV: “HbbTV 2.0 Specification,” HbbTV Association, February 2015, as well as ATSC Candidate Standard: Companion Device (A/338), Doc. S33-161r, Dec. 2, 2015, which are hereby incorporated by reference.

Although FIG. 1 illustrates one example of a computing system 100, various changes may be made to FIG. 1. For example, the system 100 could include any number of each component in any suitable arrangement. In general, computing and communication systems come in a wide variety of configurations, and FIG. 1 does not limit the scope of this disclosure to any particular configuration. While FIG. 1 illustrates one operational environment in which various features disclosed in this patent document can be used, these features could be used in any other suitable system.

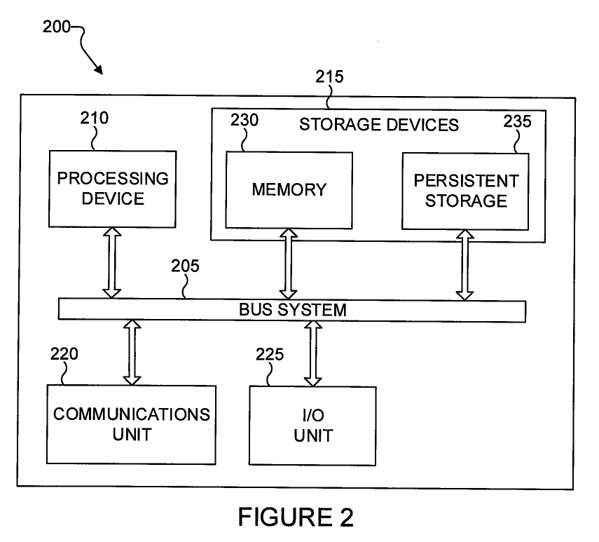

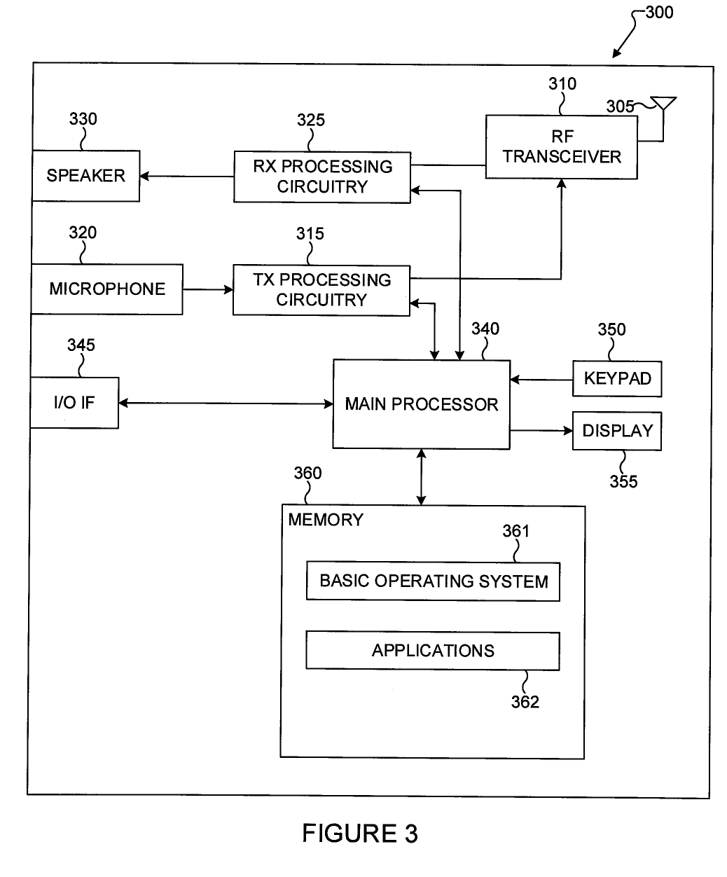

FIGS. 2 and 3 illustrate example devices in a computing system according to this disclosure. In particular, FIG. 2 illustrates an example server 200, and FIG. 3 illustrates an example client device 300. The server 200 could represent the server 104 in FIG. 1, and the client device 300 could represent one or more of the client devices 106-114 in FIG. 1.

As shown in FIG. 2, the server 200 includes a bus system 205, which supports communication between at least one processing device 210, at least one storage device 215, at least one communications unit 220, and at least one input/output (I/O) unit 225.

The processing device 210 executes instructions that may be loaded into a memory 230. The processing device 210 may include any suitable number(s) and type(s) of processors or other devices in any suitable arrangement. Example types of processing devices 210 include microprocessors, microcontrollers, digital signal processors, field programmable gate arrays, application specific integrated circuits, and discreet circuitry.

The memory 230 and a persistent storage 235 are examples of storage devices 215, which represent any structure(s) capable of storing and facilitating retrieval of information (such as data, program code, and/or other suitable information on a temporary or permanent basis). The memory 230 may represent a random access memory or any other suitable volatile or non-volatile storage device(s). The persistent storage 235 may contain one or more components or devices supporting longer-term storage of data, such as a ready only memory, hard drive, Flash memory, or optical disc.

The communications unit 220 supports communications with other systems or devices. For example, the communications unit 220 could include a network interface card or a wireless transceiver facilitating communications over the network 102. The communications unit 220 may support communications through any suitable physical or wireless communication link(s).

The I/O unit 225 allows for input and output of data. For example, the I/O unit 225 may provide a connection for user input through a keyboard, mouse, keypad, touchscreen, or other suitable input device. The I/O unit 225 may also send output to a display, printer, or other suitable output device.

Note that while FIG. 2 is described as representing the server 104 of FIG. 1, the same or similar structure could be used in one or more of the client devices 106-114. For example, a laptop or desktop computer could have the same or similar structure as that shown in FIG. 2.

As shown in FIG. 3, the client device 300 includes an antenna 305, a radio frequency (RF) transceiver 310, transmit (TX) processing circuitry 315, a microphone 320, and receive (RX) processing circuitry 325. The client device 300 also includes a speaker 330, a main processor 340, an input/output (I/O) interface (IF) 345, a keypad 350, a display 355, and a memory 360. The memory 360 includes a basic operating system (OS) program 361 and one or more applications 362.

The RF transceiver 310 receives, from the antenna 305, an incoming RF signal transmitted by another component in a system. The RF transceiver 310 down-converts the incoming RF signal to generate an intermediate frequency (IF) or baseband signal. The IF or baseband signal is sent to the RX processing circuitry 325, which generates a processed baseband signal by filtering, decoding, and/or digitizing the baseband or IF signal. The RX processing circuitry 325 transmits the processed baseband signal to the speaker 330 (such as for voice data) or to the main processor 340 for further processing (such as for web browsing data).

The TX processing circuitry 315 receives analog or digital voice data from the microphone 320 or other outgoing baseband data (such as web data, e-mail, or interactive video game data) from the main processor 340. The TX processing circuitry 315 encodes, multiplexes, and/or digitizes the outgoing baseband data to generate a processed baseband or IF signal. The RF transceiver 310 receives the outgoing processed baseband or IF signal from the TX processing circuitry 315 and up-converts the baseband or IF signal to an RF signal that is transmitted via the antenna 305.

The main processor 340 can include one or more processors or other processing devices and execute the basic OS program 361 stored in the memory 360 in order to control the overall operation of the client device 300. For example, the main processor 340 could control the reception of forward channel signals and the transmission of reverse channel signals by the RF transceiver 310, the RX processing circuitry 325, and the TX processing circuitry 315 in accordance with well-known principles. In some embodiments, the main processor 340 includes at least one microprocessor or microcontroller.

The main processor 340 is also capable of executing other processes and programs resident in the memory 360. The main processor 340 can move data into or out of the memory 360 as required by an executing process. In some embodiments, the main processor 340 is configured to execute the applications 362 based on the OS program 361 or in response to signals received from external devices or an operator. The main processor 340 is also coupled to the I/O interface 345, which provides the client device 300 with the ability to connect to other devices such as laptop computers and handheld computers. The I/O interface 345 is the communication path between these accessories and the main processor 340.

The main processor 340 is also coupled to the keypad 350 and the display unit 355. The operator of the client device 300 can use the keypad 350 to enter data into the client device 300. The display 355 may be a liquid crystal display or other display capable of rendering text and/or at least limited graphics, such as from web sites.

The memory 360 is coupled to the main processor 340. Part of the memory 360 could include a random access memory (RAM), and another part of the memory 360 could include a Flash memory or other read-only memory (ROM).

As described in more detail below, one or more embodiments of this disclosure provides broadcast-receiver-received alerts being re-sent from an ATSC 3.0 receiver to a companion device over a local area network and then rendered by a companion device native application that may be written for that purpose. Emergency Alert information is supplied to local broadcasters in the form of an Emergency Alert Message (EAM). Local broadcasters may add additional information and broadcast the resultant Emergency Alert Message to ATSC 3.0 receivers.

Although FIGS. 2 and 3 illustrate examples of devices in a computing system, various changes may be made to FIGS. 2 and 3. For example, various components in FIGS. 2 and 3 could be combined, further subdivided, or omitted and additional components could be added according to particular needs. As a particular example, the main processor 340 could be divided into multiple processors, such as one or more central processing units (CPUs) and one or more graphics processing units (GPUs). Also, while FIG. 3 illustrates the client device 300 configured as a mobile telephone or smartphone, client devices could be configured to operate as other types of mobile or stationary devices. In addition, as with computing and communication networks, client devices and servers can come in a wide variety of configurations, and FIGS. 2 and 3 do not limit this disclosure to any particular client device or server.

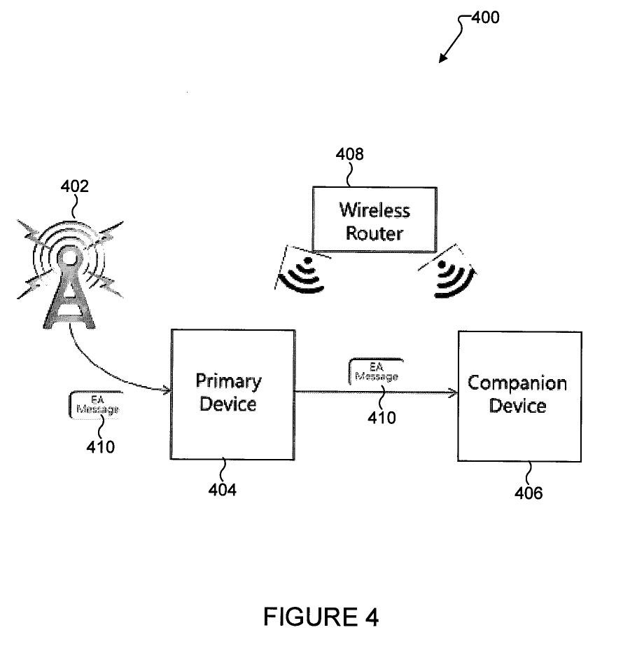

FIG. 4 illustrates example EAS home network architecture 400 according to various embodiments of the present disclosure. In this embodiment, the architecture 400 can be an example local area network, such as created by wireless access point 118, tablet 114, smartphone 108, and TV 112 as shown in FIG. 1. The embodiment of the architecture 400 illustrated in FIG. 4 is for illustration only, and the wireless access point 118 could have the same or similar configuration. However, home network architectures come in a wide variety of configurations, and FIG. 4 does not limit the scope of this disclosure to any particular implementation of home network architecture.

In FIG. 4, the architecture 400 includes an ATSC transmitter 402, a primary device (PD) 404, a companion device (CD) 406, and a wireless router 408. The PD 404 can implement an extended HbbTV 2.0 protocol that executes a TV control native application that manages a TV function to display TV content. In the application code of the PD, is an emergency alert event handler which is activated when an emergency alert message (EAM) 410 is received. This activation involves the execution of an assigned callback function to process the EAM 410 that can arrive embedded in an internet protocol (IP) packet.

In one example embodiment, the EAM 410 can be in the form of a common alerting protocol (CAP) message. The TV control application (app) is configured to provide the EAM 410 to be made available at a known uniform resource locator (URL) supported by the PD 404. An application executing on CD 406 can access the EAM 410 using this URL and then render the EAM 410 on a display of the CD 406.

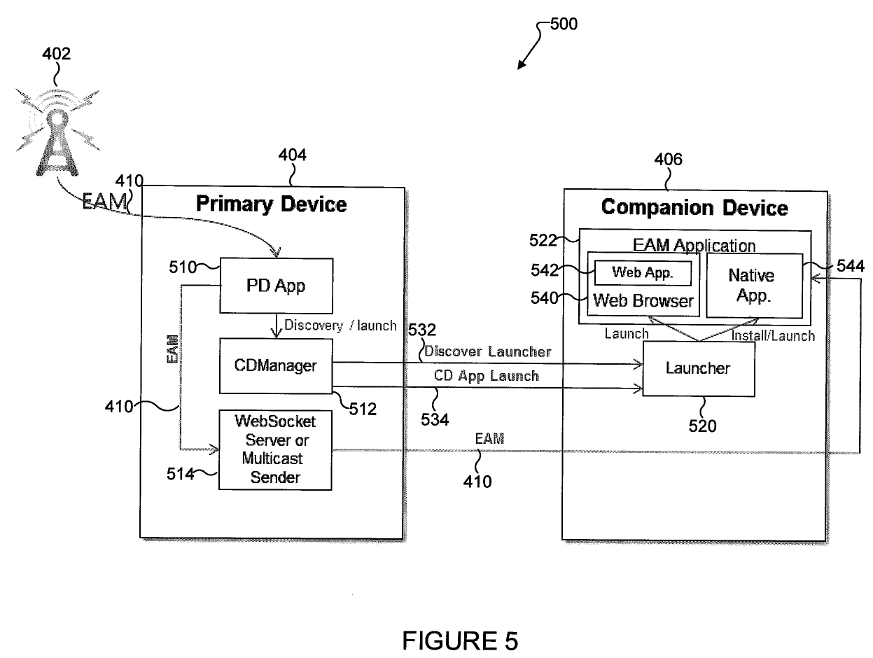

FIG. 5 illustrates an example EAS protocol 500 according to various embodiments of the present disclosure. In this embodiment, the protocol 500 can be implemented through a local area network, such as created by wireless access point 118, tablet 114, smartphone 108, and TV 112 as shown in FIG. 1. The embodiment of the protocol 500 illustrated in FIG. 5 is for illustration only, and protocols can come in a wide variety of configurations. FIG. 5 does not limit the scope of this disclosure to any particular implementation of a protocol.

In FIG. 5, the protocol 500 is used during communication between a PD 404 and CD 406. In this example embodiment, PD 404, which could be an ATSC 3.0 receiver, contains a TV control application, primary application (app) 510, and software components that support the emergency alert scheme: a CD manager 512 and a WebSocket server/multicast sender 514. The CD 406 contains an application launcher 520 and support for executing a CD application 522. A processor executing an application or the instruction of an application can perform launching an application. The CD can also be referred to as a companion screen, and the CD app can also be referred to as a companion screen application. The CD app can be an application running on a CD and either provided by a UE manufacturer for linking to and working with the terminal or provided by a service provider that can work in conjunction with a television application running on the terminal.

In one embodiment, during a PD 404 launch of CD app 522, the roles of the components may, for example:
PD app 510 resides in the PD 404 and responsible for transferring an emergency alert 410 message to available CDs in the local area network.
CD manager 512 resides in the PD 404 and is responsible for discovering 532 CDs with running launchers and sending app launch/install information 534 to those launchers.
Launcher 520 resides in the CD 406 and is responsible for communicating with the CD manager 512 of the PD 404 and launching and/or installing the CD app 522. The CD app can be launched through web browser 540 a with a web app 542 or installed and launched with a native app 544.
Emergency Alert CD app 522 resides in the CD 406 and is responsible for receiving the emergency alert message 410 from the PD 404 on the CD 406 and displaying the result on a display screen.

In one or more embodiments of this disclosure, the PD app executes a launch API which results in a command being sent to a launcher application on a CD. That launcher application then launches the CD app on that CD.

In another embodiment, during a PD app 510 to CD app 522 communication, the roles of the components may, for example:
CD manager 512 is responsible for providing service endpoints for app-to-app communication.
WebSocket server 514 resides in the PD 404 and is responsible for handling WebSocket connections from PD app 510 and from CD app 522.
Multicast sender 514 resides in the PD and is responsible for sending multicast messages from PD app 510.

In the protocol 500, the following HbbTV APIs are used:
discoverCDLaunchers( )—returns information on CDs on the local area network running launcher applications.
getApp2AppLocalBaseURL( )—returns the base URL for an app-app communications WebSocket endpoint for the PD app 510.
getApp2AppRemoteBaseURL( )—returns the base URL for an app-app communications WebSocket endpoint for a CD app 522.
launchCSApp( )—launches the CD app 522 and returns a status.

A launcher 520 is a special application executing on a CD 406. In response to a command from a PD app 510, the launcher 520 launches a native CD app 522. The CD app 522 can either embedded originally or downloaded from an application store. In this example embodiment, CD app 522 is programmed to process the emergency alert message 410.

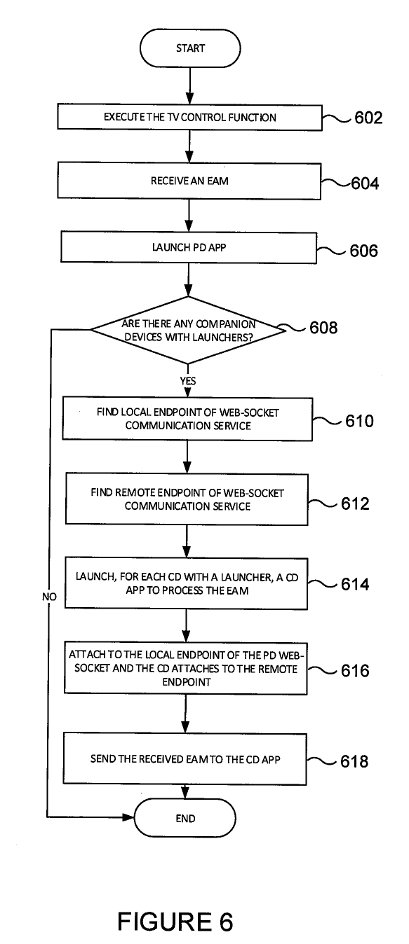

FIG. 6 illustrates a process 600 for rendering an emergency alert message on a CD display using WebSocket communication in accordance with various embodiments of the present disclosure. For example, the process 600 depicted in FIG. 6 may be performed between the PD 404 and CD 406 in FIG. 4. The embodiment of the process 600 shown in FIG. 6 is for illustration only. Other embodiments of the process 600 could be used without departing from the scope of this disclosure.

At operation 602, the PD 404 executes the TV control function. The TV control function allows the PD 404 to display the TV content on a display and to a viewer. The TV control function can be an ongoing function that operates during display of the TV content. TV content could be a guide, games, media content, and the like. The PD 404 can be an ATSC 3.0 receiver and receive digital television through an ATSC standard.

At operation 604, the PD 404 receives an EAM. The EAM can be received in the form of a common alerting protocol message. At operation 606, the PD 404 launches an embedded PD app to render the alert and manage the process of rending the EAM on CDs in the local area network. In one embodiment, the PD app can be a separate application from the TV control function, and can be downloaded separately in an app store. In other embodiments, the PD app is part of the operating system of the PD 404. In yet further embodiments, the PD app is a separate application, but preloaded into the PD 404.

At operation 608, the PD App determines whether there are CDs with launchers to then launch a CD app rending the EAM. To find the CDs with launchers, the PD 404 can issue a discoverCSLaunchers( ) command. If no CDs with launchers are discovered, then the process 600 terminates.

If there are CDs with launchers, then at operation 610, the PD app finds a local endpoint of the PD WebSocket communication service. To find the local endpoint, the PD 404 can issue a getApp2AppLocalBaseURL( ) command.

At operation 612, the PD App finds the remote endpoint of the PD WebSocket communication service. To find the remote endpoint, the PD 404 can issue a getApp2AppRemoteBaseURL( ) command.

At operation 614, the PD app launches, for each CD with a launcher, a CD App to process the EAM. The PD 404 can launch the CD app using a launchCSApp( ) command. Before operation 614, the Emergency Alert CD app to be launched is identified by a LaunchURL, and the remote endpoint of the WebSocket communication service is also identified. Each launched CD app has access to the URL of the remote endpoint of the PD communication service.

At operation 616, the PD app attaches to the local endpoint of the PD WebSocket communication service. The CD app also attaches to the remote endpoint of the PD WebSocket communication service.

When communication is established between the PD app and the CD app, at operation 618, the PD app sends the received EAM to the CD app, which subsequently processes and renders the message. After the message rendering time has expired, the WebSocket communication is terminated and the CD apps for all CDs terminate themselves. Thereafter, the process 600 terminates.

Although FIG. 6 illustrates an example process for managing a smart home, various changes could be made to FIG. 6. For example, while shown as a series of steps, various steps in each figure could overlap, occur in parallel, occur in a different order, or occur multiple times.

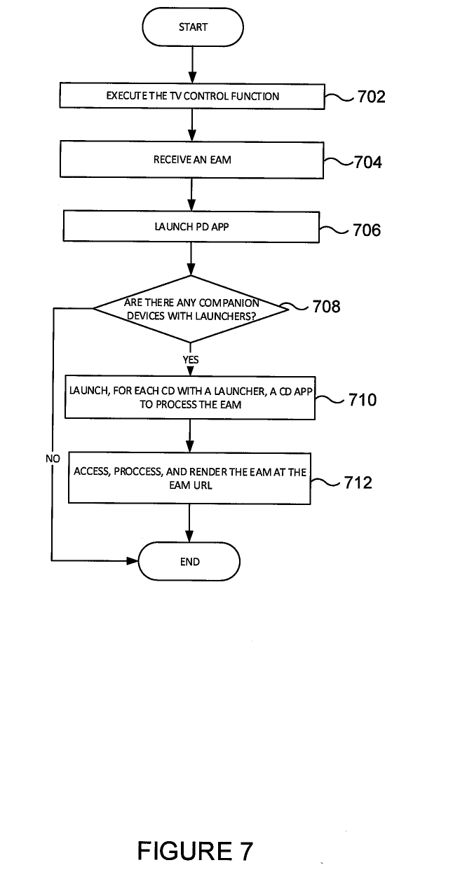

FIG. 7 illustrates a process 700 for rendering an emergency alert message on a CD display using a URL referencing the EAM on the PD in accordance with various embodiments of the present disclosure. For example, the process 700 depicted in FIG. 7 may be performed between the PD 404 and CD 406 in FIG. 4. The embodiment of the process 700 shown in FIG. 7 is for illustration only. Other embodiments of the process 700 could be used without departing from the scope of this disclosure.

At operation 702, the PD 404 executes the TV control function. The TV control function allows the PD 404 to display the TV content on a display and to a viewer. The TV control function can be an ongoing function that operates during display of the TV content. TV content could be a guide, games, media content, and the like. The PD 404 can be an ATSC 3.0 receiver and receive digital television through an ATSC standard.

At operation 704, the PD 404 receives an EAM. The EAM can be received in the form of a common alerting protocol message. At operation 706, the PD 404 launches an embedded PD app to render the alert and manage the process of rending the EAM on CDs in the local area network. In one embodiment, the PD app can be a separate application from the TV control function, and can be downloaded separately in an app store. In other embodiments, the PD app is part of the operating system of the PD 404. In yet further embodiments, the PD app is a separate application, but preloaded into the PD 404.

At operation 708, the PD App finds all CDs with launchers to then launch a CD app rending the EAM. To find the CDs with launchers, the PD 404 can issue a discoverCSLaunchers( ) command. If no CDs with launchers are discovered, then the process 700 terminates.

If there are CDs with launchers, then at operation 710, the PD app launches, for each CD with a launcher, a CD App to process the EAM. The PD 404 can launch the CD app using a launchCSApp( ) command. Before operation 710, the Emergency Alert CD app to be launched is identified by a LaunchURL, and the URL of the EAM is identified by an EamURL. Each launched CD app has access to the EamURL. The launcher on the CD launches the CD app using the LaunchURL command. The CD app is launched with the EamURL as a parameter. This allows the EAM to be available to the CD App without using app-app communication.

At operation 712, each CD app accesses, processes, and renders the EAM at the EamURL. Thereafter, the process 700 terminates.

Although FIG. 7 illustrates an example process for managing a smart home, various changes could be made to FIG. 7. For example, while shown as a series of steps, various steps in each figure could overlap, occur in parallel, occur in a different order, or occur multiple times.

In HbbTV 2.0, a JSON object can be used to help signal the CD app launch. Here, two types of CD app may be launched: a native CD app and an HTML CD app. The CD is typically a tablet device supported by the operating system environment. A one entry JSON object contains launch information for a native CD app, while a two entry JSON object contains the launch information for both a native CD App and an HTML CD app.

An example of a two entry JSON object is:

{
“launch” : [
{“launchUrl”:“g-quiz://com.examples-r-us.games.quiz-
game?colour=blue&app2app_uri=ws://192.168.1.11:992/hbbtv/”,
“appType” : “native”},
{“launchUrl”:“https://www.examples-r-us.com/quiz-fallback-app.html?
colour=blue&app2app_uri=ws://192.168.1.11:992/hbbtv/”,
“appType” : “html”}
],

with native CD App URL: g-quiz://com.examples-r-us.games.quiz-game, and HTML CD App URL: https://www.examples-r-us.com/quiz-fallback-app.html. And both, the native CD app URL and the HTML CD app URL with WebSocket remote endpoint: app2app_uri=ws://192.168.1.11:992/hbbtv.

The alternate embodiment adds to the two entry JSON Object, the URL of the EAM: EamURL given by an additional pair in the JSON object:

{“EamURL”: “http://192.168.1.11:992/hbbtv/EAM”}

Here the second entry would be a NULL entry, and therefore just a place keeper.

As an optimization of this procedure, the TV Control function itself may be considered as the PD app, and no new app need be launched.

In another embodiment, all operations of process 700 are used, except the means of delivering the EAM between the PD app and the CD app. In this embodiment, a pre-defined multicast IP address (e.g. 239.255.255.255) is used to deliver the EAM. When the CD App is launched, it subscribes to this multicast address and then receives the EAM. If there are no errors from the launchCSApp( ) then the PD app sends the EAM to the multicast address. Subsequently, CD apps receive, process, and render the EAM. After the EAS alert rendering time has expired, the CD App terminates itself

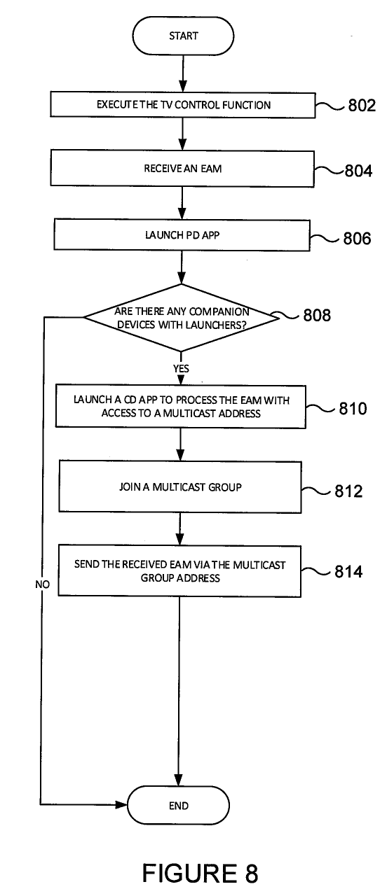

FIG. 8 illustrates a process 800 for rendering an emergency alert message on a CD display using multicast communication in accordance with various embodiments of the present disclosure. For example, the process 800 depicted in FIG. 8 may be performed between the PD 404 and CD 406 in FIG. 4. The embodiment of the process 800 shown in FIG. 8 is for illustration only. Other embodiments of the process 800 could be used without departing from the scope of this disclosure.

At operation 802, the PD 404 executes the TV control function. The TV control function allows the PD 404 to display the TV content on a display and to a viewer. The TV control function can be an ongoing function that operates during display of the TV content. TV content could be a guide, games, media content, and the like. The PD 404 can be an ATSC 3.0 receiver and receive digital television through an ATSC standard.

At operation 804, the PD 404 receives an EAM. The EAM can be received in the form of a common alerting protocol message. At operation 806, the PD 404 launches an embedded PD app to render the alert and manage the process of rending the EAM on CDs in the local area network. In one embodiment, the PD app can be a separate application from the TV control function, and can be downloaded separately in an app store. In other embodiments, the PD app is part of the operating system of the PD 404. In yet further embodiments, the PD app is a separate application, but preloaded into the PD 404.

At operation 808, the PD App finds all CDs with launchers to then launch a CD app rending the EAM. To find the CDs with launchers, the PD 404 can issue a discoverCSLaunchers( ) command. If no CDs with launchers are discovered, then the process 800 terminates.

If there are CDs with launchers, then at operation 810, the PD app launches, for each CD with a launcher, a CD App to process the EAM. The PD 404 can launch the CD app using a launchCSApp( ) command. Before operation 810, the Emergency Alert CD app to be launched is identified by a LaunchURL, and the address of a multicast group for delivery of the EAMs is also identified. Each launched CD app has access to the multicast address.

At operation 812, each CD app joins the multicast group. At operation 814, the multicast sender sends the received EAM via the multicast group address to the CD app, which subsequently processes and renders the EAM. After the message rendering time has expired, the CD apps for all CDs terminate themselves. Thereafter, the process 800 terminates.

Although FIG. 8 illustrates an example process for managing a smart home, various changes could be made to FIG. 8. For example, while shown as a series of steps, various steps in each figure could overlap, occur in parallel, occur in a different order, or occur multiple times.

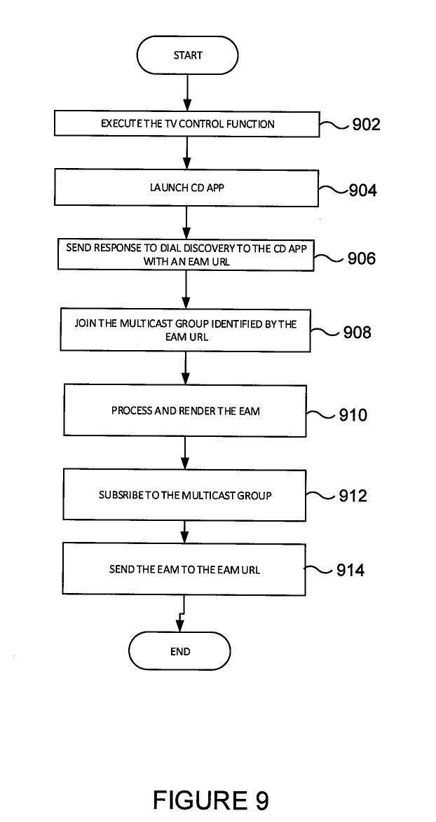

FIG. 9 illustrates a process 900 for rendering an emergency alert message on a CD display using WebSocket communication by starting in the CD in accordance with various embodiments of the present disclosure. For example, the process 900 depicted in FIG. 9 may be performed between the PD 404 and CD 406 in FIG. 4. The embodiment of the process 900 shown in FIG. 9 is for illustration only. Other embodiments of the process 900 could be used without departing from the scope of this disclosure.

At operation 902, the PD 404 executes the TV control function. The TV control function allows the PD 404 to display the TV content on a display and to a viewer. The TV control function can be an ongoing function that operates during display of the TV content. TV content could be a guide, games, media content, and the like. The PD 404 can be an ATSC 3.0 receiver and receive digital television through an ATSC standard.

At operation 904, a CD app on a CD started by a user discovers the PD using a discovery and launch (DIAL) protocol. At operation 906, a result of using the DIAL discovery protocol, a response is sent from the PD to the CD app containing a service endpoint which itself contains an EamURL. At operation 908, the CD app then joins the multicast group identified by the EamURL (e.g. 240.255.255.255).

When the PD TV function encounters an EAM, at operation 910, the PD TV function processes and renders the EAM. At operation 912, the PD TV function subscribes to the multicast group identified by the EamURL. At operation 914, the PD TV function sends the EAM to the EamURL. All CD Apps on CDs subscribed to the multicast group identified by the EamURL receive, process, and render the EAM and remain active awaiting other EAMs.

Although FIG. 9 illustrates an example process for managing a smart home, various changes could be made to FIG. 9. For example, while shown as a series of steps, various steps in each figure could overlap, occur in parallel, occur in a different order, or occur multiple times.

None of the description in this application should be read as implying that any particular element, step, or function is an essential element that must be included in the claim scope. The scope of patented subject matter is defined only by the claims. Moreover, none of the claims is intended to invoke 35 U.S.C. §112(f) unless the exact words “means for” are followed by a participle.

What is claimed is:

1. An apparatus comprising:
a memory element; and
a processor coupled to the memory element, the processor configured to:
receive an emergency alert message (EAM) in an advanced television systems committee (ATSC) signal;
identify any companion devices that comprise a launcher application capable of being used by the apparatus;
send a command to the launcher application capable of causing the launcher application to execute an application to an identified companion device that comprises the launcher application,
wherein the application is capable of accessing the EAM.

2. The apparatus of claim 1, wherein the processor is further configured to:
identify local and remote endpoints for a WebSocket server;
connect to the WebSocket server using the local endpoint;
send the remote endpoint to the identified companion device,
wherein the application of the identified companion device is capable of using the remote endpoint to connect to the WebSocket server to access the EAM.

3. The apparatus of claim 1, wherein the processor is further configured to:
send multicast information to the identified companion device, the multicast information comprising a multicast address and multicast port; and
send the EAM to the multicast address,
wherein the application of the identified companion device is capable of using the multicast address and multicast port to access the EAM.

4. The apparatus of claim 1, wherein the EAM is received using a common alerting protocol.

5. The apparatus of claim 1, wherein the apparatus is a hybrid broadcast broadband television terminal.

6. The apparatus of claim 1, wherein the companion device is not a hybrid broadcast broadband television terminal.

7. The apparatus of claim 1, wherein the application is separate from the operating system of the identified companion device.

8. The apparatus of claim 1, wherein the apparatus and the identified companion device communicate through a local area network.

9. The apparatus of claim 2, wherein the WebSocket server is within the apparatus.

10. The apparatus of claim 1, wherein the apparatus specifies the application within the command.

11. A method comprising:
receiving, at a primary device, an emergency alert message (EAM) in an advanced television systems committee (ATSC) signal;
identifying any companion devices that comprise a launcher application capable of being used by the primary device;
sending a command to the launcher application capable of causing the launcher application to execute an application to an identified companion device that comprises the launcher application,
wherein the application is capable of accessing the EAM.

12. The method of claim 11, further comprising:
identifying local and remote endpoints for a WebSocket server;
connecting to the WebSocket server using the local endpoint;
sending the remote endpoint to the identified companion device,
wherein the application of the identified companion device is capable of using the remote endpoint to connect to the WebSocket server to access the EAM.

13. The method of claim 11, further comprising:
sending multicast information to the identified companion device, the multicast information comprising a multicast address and multicast port; and
sending the EAM to the multicast address,
wherein the application of the identified companion device is capable of using the multicast address and multicast port to access the EAM.

14. The method of claim 11, wherein the EAM is received using a common alerting protocol.

15. The method of claim 11, wherein the primary device is a hybrid broadcast broadband television terminal.

16. The method of claim 11, wherein the companion device is not a hybrid broadcast broadband television terminal.

17. The method of claim 11, wherein the application is separate from the operating system of the identified companion device.

18. The apparatus of claim 11, wherein the primary device and the identified companion device communicate through a local area network.

19. The method of claim 12, wherein the WebSocket server is within the primary device.

20. The method of claim 11, wherein the primary device specifies the application within the command.
